(19) United States
(12) Patent Application Publication
(10) Pub. No.: US 2025/0310194 A1
(43) Pub. Date: Oct. 2, 2025

(54) CLOUD INSTANCE SIZING AND DEPLOYMENTS USING MACHINE LEARNING

(71) Applicant: Dell Products L.P., Round Rock, TX (US)

(72) Inventors: Bijan Kumar Mohanty, Austin, TX (US); David J. Linsey, Marietta, GA (US); Hung Dinh, Austin, TX (US)

(21) Appl. No.: 18/618,687

(22) Filed: Mar. 27, 2024

(51) Int. Cl. H04L 41/0823; H04L 41/16; H04L 67/10

(52) U.S. Cl. CPC H04L 41/0823; H04L 41/16; H04L 67/10

(57) ABSTRACT

A method comprises receiving a request to predict a configuration of a cloud instance in which at least one application is to be executed, wherein the request includes one or more features of the at least one application. The one or more features are analyzed using one or more machine learning algorithms. Based at least in part on the analyzing, the configuration of a cloud instance in which at least one application is to be executed is predicted. The configuration comprises an amount of utilization for one or more computer resources in connection with execution of the at least one application in the cloud instance.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to cloud instance size prediction in information processing systems.

### BACKGROUND

Cloud-based software deployments permit software developers to build and run applications without having to manage underlying hardware and associated foundational software, such as operating systems. However, software developers are still required to select the virtual environments in which applications may run. The number of virtual instance options offered by various cloud providers is extremely large. Moreover, given the increased number of cloud native microservices and micro-frontend (MFE) applications being deployed on containerized and other virtualized platforms, virtual environment selection has become increasingly complex.

### SUMMARY

Embodiments provide a cloud instance prediction platform in an information processing system.

For example, in one embodiment, a method comprises receiving a request to predict a configuration of a cloud instance in which at least one application is to be executed, wherein the request includes one or more features of the at least one application. The one or more features are analyzed using one or more machine learning algorithms. Based at least in part on the analyzing, the configuration of a cloud instance in which at least one application is to be executed is predicted. The configuration comprises an amount of utilization for one or more computer resources in connection with execution of the at least one application in the cloud instance.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a cloud instance prediction platform according to an illustrative embodiment.

FIG. 2 depicts an operational flow for cloud instance prediction according to an illustrative embodiment.

FIG. 3 depicts an operational flow for prediction of a cloud instance configuration and corresponding cloud provider according to an illustrative embodiment.

FIG. 4 depicts sample training data for training a machine learning algorithm to predict a cloud instance configuration and a corresponding cloud provider according to an illustrative embodiment.

FIG. 5A depicts example pseudocode for importation of libraries according to an illustrative embodiment.

FIG. 5B depicts example pseudocode for loading historical cloud application data into a data frame according to an illustrative embodiment.

FIG. 6 depicts example pseudocode for encoding a dataset for machine learning according to an illustrative embodiment.

FIG. 7 depicts example pseudocode for normalizing and reducing dimensionality of a dataset according to an illustrative embodiment.

FIG. 8 depicts example pseudocode for splitting a dataset into training and testing components and for creating separate datasets for independent and dependent variables according to an illustrative embodiment.

FIG. 9A depicts example pseudocode for using a designated library to build a neural network according to an illustrative embodiment.

FIG. 9B depicts example pseudocode for building a cloud provider branch of a neural network according to an illustrative embodiment.

FIG. 9C depicts example pseudocode for building a compute utilization branch of a neural network according to an illustrative embodiment.

FIG. 9D depicts example pseudocode for building a memory utilization branch of a neural network according to an illustrative embodiment.

FIG. 9E depicts example pseudocode for building an input-output value branch of a neural network according to an illustrative embodiment.

FIG. 9F depicts example pseudocode for assembling a neural network and setting a loss function, metrics and an optimizer of a neural network according to an illustrative embodiment.

FIG. 10A depicts example pseudocode for training a neural network model according to an illustrative embodiment.

FIG. 10B depicts example pseudocode for computing loss of a neural network model according to an illustrative embodiment.

FIG. 10C depicts example pseudocode for computing a prediction with a neural network model according to an illustrative embodiment.

FIG. 11 depicts an operational diagram corresponding to operation of the cloud interfacing and monitoring engine according to an illustrative embodiment.

FIGS. 12A and 12B depict example pseudocode for retrieval of central processing unit (CPU) utilization metrics from a first cloud provider platform according to an illustrative embodiment.

FIGS. 13A and 13B depict example pseudocode for retrieval of CPU utilization metrics from a second cloud provider platform according to an illustrative embodiment.

FIGS. 14A and 14B depict example pseudocode for retrieval of CPU utilization and disk input-output metrics from a third cloud provider platform according to an illustrative embodiment.

FIG. 15 depicts a process for cloud instance configuration prediction according to an illustrative embodiment.

FIGS. 16 and 17 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a requesting device receives messages without any significant time delay. Of course, it should be understood that depending on the particular temporal nature of the system in which an embodiment is implemented, other appropriate timescales that provide at least contemporaneous performance and output can be achieved.

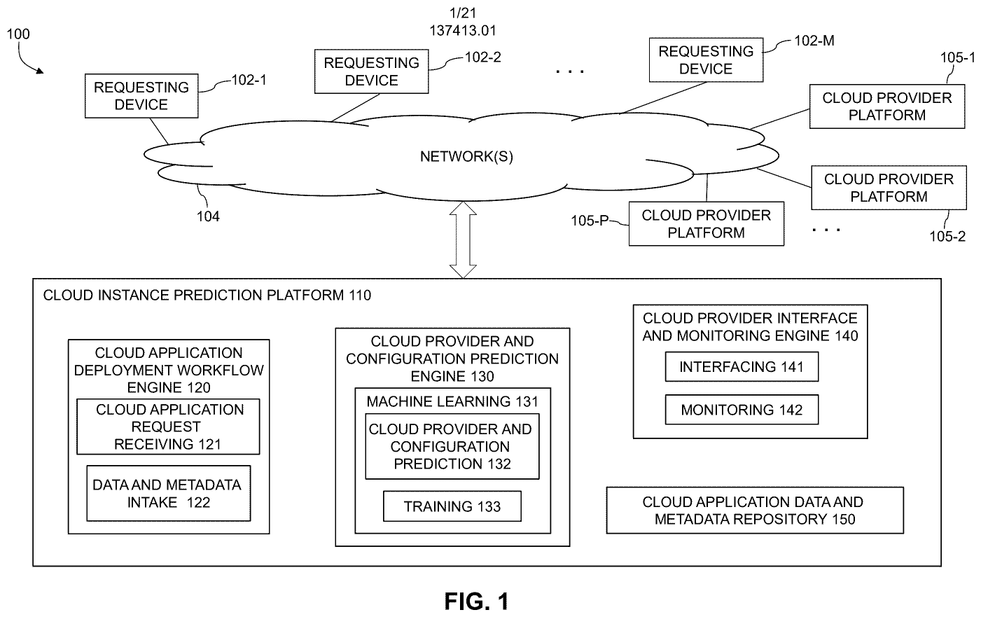

FIG. 1 shows an information processing system 100 configured in accordance with an illustrative embodiment. The information processing system 100 comprises requesting devices 102-1, 102-2, . . . 102-M (collectively “requesting devices 102”) and cloud provider platforms 105-1, 105-2, . . . 105-P (collectively “cloud provider platforms 105”). The requesting devices 102 and cloud provider platforms 105 communicate over a network 104 with a cloud instance prediction platform 110. The variable M and other similar index variables herein such as K, L, S and P are assumed to be arbitrary positive integers greater than or equal to one.

The requesting devices 102 and one or more devices of the cloud provider platforms 105 can comprise, for example, Internet of Things (IoT) devices, server, desktop, laptop or tablet computers, mobile telephones, or other types of processing devices capable of communicating with the cloud instance prediction platform 110 over the network 104. Such devices are examples of what are more generally referred to herein as “processing devices.” Some of these processing devices are also generally referred to herein as “computers.” The requesting devices 102 and one or more devices of the cloud provider platforms 105 may also or alternately comprise virtualized computing resources, such as virtual machines (VMs), containers, etc. The requesting devices 102 and/or one or more devices of the cloud provider platforms 105 in some embodiments comprise respective computers associated with a particular company, organization or other enterprise.

The terms “customer,” “administrator,” “personnel” or “user” herein are intended to be broadly construed so as to encompass numerous arrangements of human, hardware, software or firmware entities, as well as combinations of such entities. Cloud instance prediction services may be provided for users utilizing one or more machine learning models, although it is to be appreciated that other types of infrastructure arrangements could be used. At least a portion of the available services and functionalities provided by the cloud instance prediction platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the cloud instance prediction platform 110, as well as to support communication between the cloud instance prediction platform 110 and connected devices (e.g., requesting devices 102 and one or more devices of the cloud provider platforms 105) and/or other related systems and devices not explicitly shown.

In some embodiments, the requesting devices 102 are assumed to be associated with repair technicians, system administrators, information technology (IT) managers, software developers, release management personnel or other authorized personnel configured to access and utilize the cloud instance prediction platform 110. The requesting devices 102 can also be respectively associated with one or more customers requiring the services of one or more cloud providers. Some non-limiting examples of cloud providers that may correspond to the cloud provider platforms 105 include, but are not necessarily limited to, Amazon® Web Services (AWS®), Azure®, Google® Cloud Platform (GCP®), Oracle® and/or VMWare® Tanzu® cloud providers.

As noted hereinabove, the number of virtual instance options offered by various cloud providers is extremely large. With the increased number of cloud native microservices and MFE applications being deployed on containerized and other virtualized platforms, virtual environment selection has become increasingly complex. For example, when compared with each other, applications may behave differently and have their own resource requirements. Regardless of their size and atomicity, microservices and MFEs demand resources based on a variety of factors including, but not limited to, the size of a code base, and various complexity factors such as, for example, cyclomatic complexity, dependencies, data handling, caching, integration requirements, scaling requirements and volume requirements. Although cloud providers may provide options in terms of VM sizing, current cloud provider solutions do not provide fine-grained customized and predicted configurations for virtual cloud instances that correspond to a given application and its complex and multi-dimensional features. Due to the lack of this capability, many runtime environments for applications (e.g., microservices and MFEs) are over or under sized, causing unwanted scaling up or down of an environment, which can negatively impact performance, increase cost and waste compute resources.

In order to address the problems with current approaches, illustrative embodiments provide technical solutions which use machine learning to intelligently recommend cloud instance configurations and optimum cloud providers for different applications. For example, depending on application features, applications may require differently configured virtual instances and different cloud providers. The embodiments advantageously provide a cloud instance prediction framework that permits intelligent prediction of cloud instance configuration including utilization amounts of various compute resources and selection of properly equipped cloud provider platforms on which the cloud instances can be deployed. The embodiments provide a cloud instance prediction framework which intelligently selects appropriate containers and/or other virtual instances based on systemically predicated resource needs of an application. Leveraging machine learning, the framework predicts optimal cloud instance configurations and cloud providers for cloud applications based on historical data and metadata corresponding to multiple application features.

The cloud instance prediction platform 110 in the present embodiment is assumed to be accessible to the requesting devices 102 and/or cloud provider platforms 105 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the cloud instance prediction platform 110 includes a cloud application deployment workflow engine 120, a cloud provider and configuration prediction engine 130, a cloud provider interface and monitoring engine 140 and a cloud application data and metadata repository 150. The cloud application deployment workflow engine 120 includes a cloud application request receiving layer 121 and a data and metadata intake layer 122. The cloud provider and configuration prediction engine 130 includes a machine learning layer 131 comprising a cloud provider and configuration prediction layer 132 and a training layer 133. The cloud provider interface and monitoring engine 140 includes an interfacing layer 141 and a monitoring layer 142.

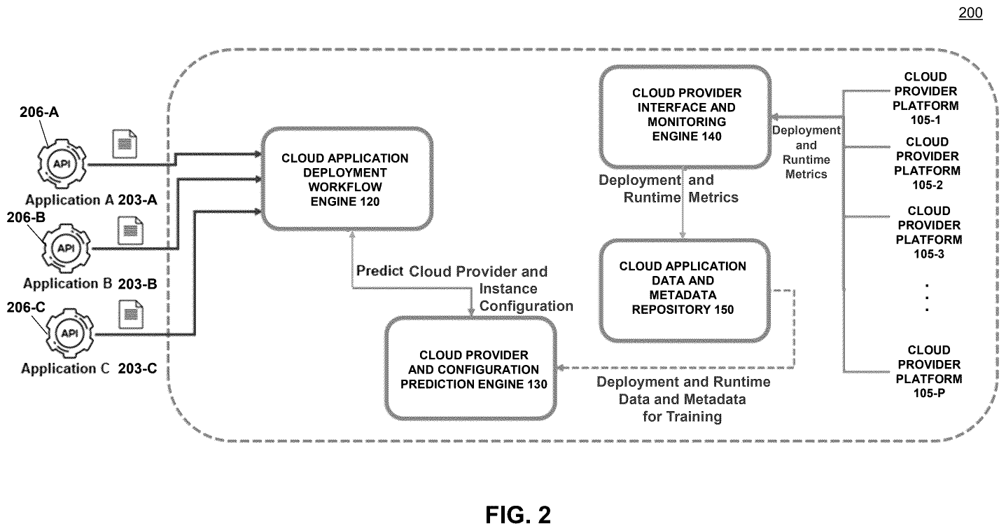

The cloud application request receiving layer 121 of the cloud application deployment workflow engine 120 receives cloud application requests from one or more requesting devices 102. Referring to the operational flow 200 of FIG. 2, in a non-limiting illustrative embodiment, the cloud application deployment workflow engine 120 (e.g., cloud application request receiving layer 121) receives requests from applications running on the requesting devices 102. For example, the cloud application requests may be initiated from application A 203-A, application B 203-B and application C 203-C (collectively “applications 203”) and comprise application programming interface (API) calls using one or more APIs (e.g., API 206-A, API 206-B and API 206-C (collectively “APIs 206”). In some embodiments, the requests may be automated or initiated by one or more users of the requesting devices 102. As explained in more detail herein, the cloud application deployment workflow engine 120 identifies cloud providers and cloud instance configurations for applications to be run in a cloud environment by invoking a request to the cloud provider and configuration prediction engine 130 to predict a cloud provider and cloud instance configuration for a given application. The cloud provider and configuration prediction engine 130 leverages machine learning to predict an optimal cloud instance configuration and cloud provider for the given application.

The data and metadata intake layer 122 collects and processes data and metadata received in a request for cloud instance prediction of a cloud application. The data and metadata for a cloud application to be deployed may be included with a cloud application request from one or more requesting devices 102, and can be collected from, for example, the cloud application request receiving layer 121. The data and metadata for a cloud application to be deployed is sent to and stored in the cloud application data and metadata repository 150. The data and metadata for a cloud application to be deployed comprise, for example, one or more features identifying at least one of a size of code for the application, a language of the code for the application, a complexity tier of the application, an interactivity determination of the application (yes or no depending on if the application is intended to be used in an interactive manner), a cold start time of the application, an execution time of the application, a memory consumption of the application and a cost of the application (e.g., deployment cost, storage cost, network overhead, etc.). In illustrative embodiments, a complexity tier of an application is based on cyclomatic, dependency and/or integration complexity as returned by code coverage tools such as, for example, SonarQube®, etc. Cold start time and execution time may be, for example, average or median times. One or more of the features can be in the form of data in addition to or as an alternative metadata.

In more detail, in illustrative embodiments, cyclomatic complexity measures, for example, the number of linearly independent paths through code. For a given application, the embodiments account for code loops, branches and connected components, of which all can have an effect on virtual CPU (vCPU) demand. In connection with coding language, the embodiments consider code language(s) (e.g., JAVA, JSON, Python, etc.) used for a given application and a percentage of the number of lines of code corresponding to each development language. Different languages can have different resource overhead, especially when comparing interpreted, ahead-of-time (AOT) compiled, and just-in-time (JIT) compiled languages.

Libraries used may be another relevant feature analyzed by the machine learning algorithms in connection with predicting cloud instance configurations and optimum cloud providers for different applications. For example, in illustrative embodiments, the machine learning layer 131 of the cloud provider and configuration prediction engine 130 analyzes external libraries/drivers that are bound to an application. The libraries/drivers may be public or private. Fingerprint assessment of libraries bound to an application can facilitate identification of resources that are shared to run the libraries. Additionally, knowledge of certain libraries used by applications provides a machine learning algorithm with an indication of an ultimate purpose and behavior of an application. For example, an application using Spring Web is likely different operationally from an application using Spring for Apache Kafka.

The embodiments further consider the number and types of external integrations (e.g., data source connections, API calls in or out, connections to queues, etc.) associated with an application. For example, external integrations and their protocols (e.g., HTTPS, sockets, file, JDBC) can affect the volume of required input-output I/O operations. The embodiments also consider what functions an application may be performing such as, for example, caching and/or cryptography. Caching applications may require large amounts of memory, while cryptography may draw heavily on vCPU resources.

Additional features considered can include, for example, anticipated load, load patterns (such as highs and lows) and tolerance for warm up periods. Some of these features may not be automatically discoverable from application code analysis and may require user intervention to determine their values. The remaining features can be assessed from static code analysis, without running the application. The features are analyzed by one or more machine learning algorithms used by the machine learning layer 131, which is trained based on data from other known applications already running on cloud instances. In illustrative embodiments, the one or more machine learning algorithms use the features of an application as input and apply appropriate weighting to each parameter and associated value, based on previous observations of applications running on various virtual cloud instance configurations.

In illustrative embodiments, the cloud provider and configuration prediction layer 132 predicts optimal configuration parameters (e.g., resource size, utilization, volume, etc.) of a runtime environment for a cloud native application (e.g., microservice and/or MFE component) in a multi-cloud environment. In addition to predicting the optimal utilization of, for example, compute, memory, disk I/O and storage for a cloud instance, the cloud provider and configuration prediction layer 132 also predicts an optimal cloud provider platform 105 to host the cloud instance in which the cloud native application will run. As explained in more detail herein, the cloud provider interface and monitoring engine 140 interfaces with multiple (e.g., thousands) of cloud native applications in a multi-cloud environment and retrieves historical deployment and runtime metrics of the cloud native applications running in different virtual cloud instances. The data includes features of the applications, as well as the configurations of the cloud instances. The training layer 133 uses the data to train a sophisticated multi-target capable neural network, which includes regressors and a classifier to yield multiple outputs.

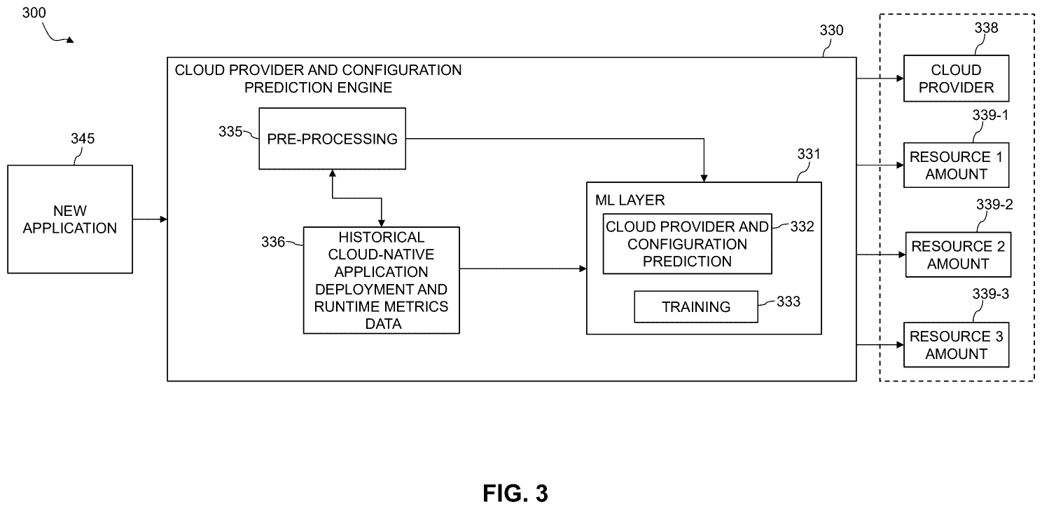

In more detail, referring to the operational flow 300 in FIG. 3, a detailed explanation of an embodiment of a cloud provider and configuration prediction engine 330 is described. The cloud provider and configuration prediction engine 330 may be the same as or similar to the cloud provider and configuration prediction engine 130. A new application request 345 (e.g., microservice, MFE application, etc.) the same as or similar to a request for an application described in connection with FIGS. 1 and 2 is received from, for example, a cloud application deployment workflow engine 120 and input to the cloud provider and configuration prediction engine 330. The cloud provider and configuration prediction engine 330 illustrates a pre-processing component 335, which processes the incoming request and the historical cloud-native application deployment and runtime metrics data 336 for analysis by the machine learning (ML) layer 331. For example, the pre-processing component 335 removes any unwanted characters, punctuation, and stop words. The pre-processing component 335 performs data engineering and data pre-processing to isolate features and data elements that will be influencing the machine learning algorithm and predictions. In illustrative embodiments, the data engineering and data pre-processing includes encoding of categorical and textual attributes. In some embodiments, the data engineering and data pre-processing may include generation of multivariate plots and/or correlation heatmaps to identify the significance of each feature in the dataset so that less important data elements are filtered (e.g., removed or assigned less weight). As a result, the dimensions and complexity of the model are reduced, hence improving accuracy and performance of the model.

As can be seen in FIG. 3, the cloud provider and configuration prediction engine 330 predicts various resource amounts 339-1, 339-2 and 339-3 (collectively

“resource amounts 339”) for configuring a cloud instance (e.g., container or other virtual instance) to execute/run an application that is the subject of the new application request 345. The resource amounts 339 include, but are not necessarily limited to, central processing unit utilization (e.g., number of CPU cores (millicores)), memory utilization (mebibytes (MiB)) (e.g., RAM and/or ephemeral storage) and disk input-output (I/O) utilization (MiB/s). Disk I/O comprises, for example, read, write and other I/O operations corresponding to a physical disk. Disk I/O may include measurements of active disc I/O time including, for example, the rate at which data is transferred from a hard drive to the RAM. The cloud provider and configuration prediction engine 330 also predicts a cloud provider 338 to host the cloud instance. The predictions are performed using the ML layer 331 comprising a cloud provider and configuration prediction layer 332 and a training layer 333. The ML layer 331 is the same as or similar to machine learning layer 131. In illustrative embodiments, the cloud provider and configuration prediction layer 332 determines, based on training data comprising the historical cloud-native application deployment and runtime metrics data 336 collected by the cloud provider interface and monitoring engine 140, a cloud provider 338 to host the cloud instance, and resource amounts 339 for a cloud instance in which an application will be executed. The cloud instance can comprise, for example, a container, VM or other virtual instance.

In an illustrative embodiment, as described in more detail herein, the ML layer 331 utilizes a multi-output neural network comprising a deep neural network that has four parallel branches corresponding to the four outputs 338 and 339-1, 339-2 and 339-3. By taking the same set of input variables as a single input layer and building a dense multi-layer neural network, ML layer 331 functions as a sophisticated parallel classifier and regressor for multi-output predictions.

The training data input to the training layer 133/333 (e.g., the historical cloud-native application deployment and runtime metrics data 336) includes application features as well runtime metrics of the applications. The features include, but are not necessarily limited to, the code size of an application, application type (e.g., microservice, MFE, etc.), programming language, complexity tier (based on, for example, cyclomatic, dependency and integration complexity as returned by the code coverage tools like SonarQube®, etc.), interactivity (yes or no depending on, for example, if the application (e.g., microservice, MFE, etc.) is intended to be used in an interactive manner), average execution time of the application, along with the target labels (e.g., cloud provider, CPU utilization, memory utilization, disk I/O utilization).

The cloud provider interface and monitoring engine 140 collects historical cloud-native application deployment and runtime metrics data and metadata for cloud applications from the cloud provider platforms 105 (e.g., cloud provider platforms 105-1, 105-2, . . . 105-P). The collected deployment and runtime data and metadata is sent to and stored in the cloud application data and metadata repository 150. The historical deployment and runtime data and metadata comprises, for example, respective ones of a plurality of applications associated with at least one of: (i) a code size; (ii) a code language; (iii) a complexity tier; (iv) an interactivity determination; (v) a cold start time (e.g., average, median, etc.); (vi) an execution time (e.g., average, median, etc.); (vii) CPU utilization; (viii) memory utilization; (ix) disk I/O utilization; and (x) a cost (e.g., deployment cost, storage cost, network overhead, etc.). One or more of the features can be in the form of data in addition to or as an alternative to metadata.

As explained in more detail herein, historical deployment data and metadata from the cloud application data and metadata repository 150 is used by the cloud provider and configuration prediction engine 130 to train one or more machine learning models to accurately predict a cloud provider and a cloud instance configuration for a newly received request for deployment and execution of a cloud application in a cloud instance on a cloud provider platform 105. In some embodiments, historical deployment data and metadata is used as a first training dataset, and following deployment, real-time or close to real-time runtime metrics data and metadata is used as a second (subsequent) training dataset to fine-tune the one or more machine learning algorithms that have been trained with the first training dataset.

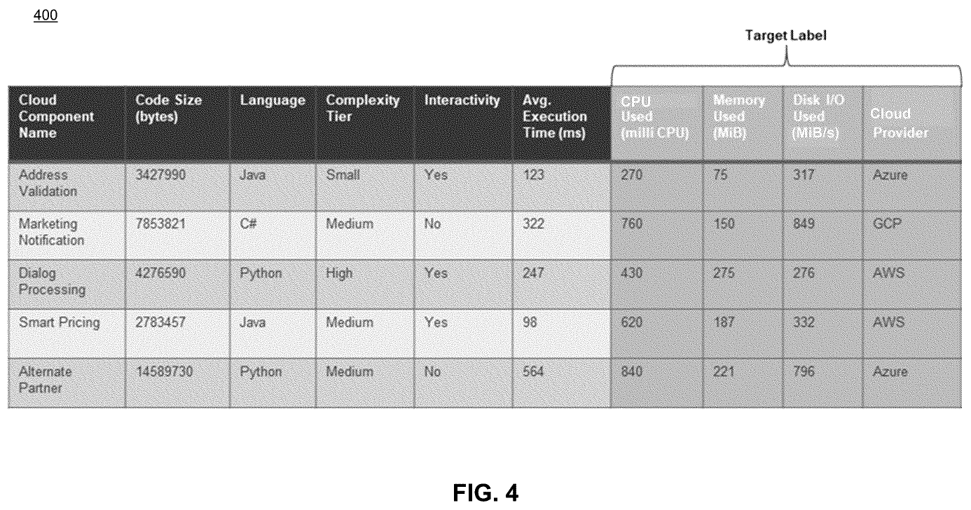

FIG. 4 depicts a table 400 of sample historical deployment data and metadata and/or runtime metrics data and metadata that may be used to train the one or more machine learning models used for cloud provider prediction and cloud instance configuration prediction by the cloud provider and configuration prediction engine 130. It is to be understood that the data illustrated in table 400 is illustrative, and the embodiments are not necessarily limited to what is shown in FIG. 4. Historical deployment data and metadata and/or runtime metrics data and metadata with more or less features may be used in other embodiments. As can be seen in the table 400, the training data identifies multi-dimensional features. The features include, for example, a cloud application name (cloud component name), a code size (e.g., in bytes), a code language (e.g., JAVA, C#, Python), a complexity tier (e.g., small, medium, high), an interactivity determination (yes/no) and an average execution time (e.g., in milliseconds). The target variables (e.g., target labels) include CPU utilization (millicores), memory utilization (e.g., MiB), disk I/O utilization (MiB/s) and cloud providers. The target variables are predicted by the machine learning layer 131/331 of the cloud provider and configuration prediction engine 130/330.

The cloud provider and configuration prediction engine 130/330, more particularly, the training layer 133/333 of the machine learning layer 131/331 uses the historical deployment data and metadata and/or runtime metrics data and metadata collected by the cloud provider interface and monitoring engine 140 to train one or more machine learning algorithms used by the cloud provider and configuration prediction layer 132/332 to predict a cloud provider and the configuration of a cloud instance for the deployment and execution of a given application.

The cloud provider and configuration prediction layer 132/332 of the cloud provider and configuration prediction engine 130/330 predicts, with a high degree of accuracy, a cloud provider and cloud instance configuration to deploy and execute a given application. The prediction is based, at least in part, on a variety of features used in the training data received from the cloud application data and metadata repository 150. Given the complexity, dimensionality and inter-relationship of the variety of features, illustrative embodiments utilize a deep learning approach.

The illustrative embodiments require multi-target prediction, which uses regressors and a classifier in a deep neural network-based architecture. Referring to the operational flow 300 in FIG. 3, four targets (cloud provider 338 and resource amounts 339 (e.g., CPU utilization, memory utilization, disk I/O utilization)) are predicted from the same set of input features. While the first label for prediction (cloud provider 338) is computed using a classification approach, the remaining three labels (resource amounts 339) are predicted using a regression mechanism.

The cloud provider and configuration prediction engine 130/330 utilizes deep neural network by building a dense, multi-layer neural network to act as a sophisticated classifier and regressors. The machine learning layer 131/331 utilizes a multi-output neural network, which is a deep neural network that has four parallel branches for four types of outputs. By taking the same set of input variables as a single input layer and building a dense, multi-layer neural network this component functions as a network with one classifier and three regressors for multi-output predictions. The neural network comprises an input layer, one or more hidden layers and an output layer. As a multi-output neural network, four separate branches of the network are generated where each branch includes 2 hidden layers and an output layer that connects to the same (universal) input layer. The input layer includes a number of neurons that matches the number of input/independent variables (e.g., input features). In an illustrative embodiment, each branch includes two hidden layers and the number of neurons in each hidden layer depends upon the number of neurons in the input layer. The output layer for each branch may include different numbers of neurons depending upon the type of output needed. In this situation, for the first branch of the network, which is a classifier and used for predicting the cloud provider type, the output layer includes, for example, four neurons (or more depending upon the number of types of cloud providers) and a softmax activation function. The respective output layers for the remaining three branches, which are designed to be regressors and to predict the configuration of a cloud instance (e.g., compute, memory, and disk I/O utilization amounts), will include one neuron with a linear or no activation function. The neurons in the hidden layers use a rectified linear unit (ReLu) activation function for all 4 branches.

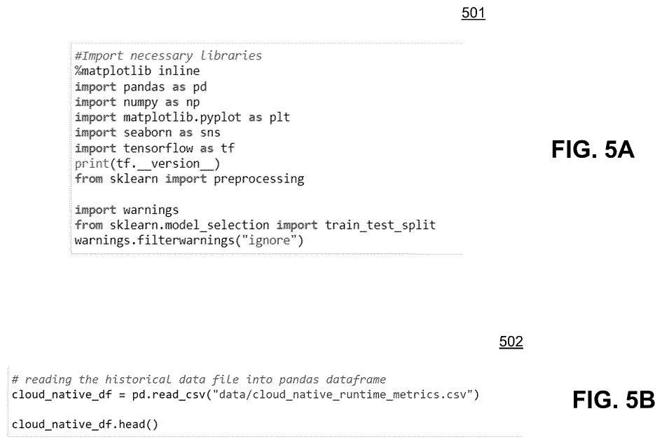

In connection with the operation of the cloud provider and configuration prediction engine 130, FIG. 5A depicts example pseudocode 501 for importation of libraries used to implement the cloud provider and configuration prediction engine 130. For example, Tensorflow®, Keras, Python, ScikitLearn, Pandas and/or Numpy libraries can be used. Data pre-processing is performed by the pre-processing component 335 and/or the cloud application data and metadata repository 150 to identify important features of the historical deployment and/or runtime metrics data and metadata. In more detail, a training dataset is read and a data frame (e.g., Pandas data frame) corresponding to the training dataset is generated. The data frame comprises a plurality of partitioned independent variables (e.g., partitioned in columns) representing the input features (e.g., code size, code language, complexity, interactivity, execution time, etc.) and the dependent/target variable columns (cloud provider, CPU utilization, memory utilization, disk I/O utilization). An initial step is to pre-process the data to address any null or missing values in the partitions (e.g., columns). Null and/or missing values in partitions with numerical data can be replaced by the median value of that partition or other average value (e.g., mean). After generating univariate and/or bivariate plots of the partitions, the importance and influence of each partition is determined. Partitions that have little or no role or influence on the actual prediction (target variables) can be dropped. In other words, one or more of a plurality of partitioned independent variables are identified to be removed from the training dataset based at least in part on whether the one or more of the plurality of partitioned independent variables factor into the prediction of the cloud provider, CPU utilization, memory utilization and/or disk I/O utilization. The identified one or more of the plurality of partitioned independent variables are removed from the training dataset, and the machine learning model is trained with the modified training dataset.

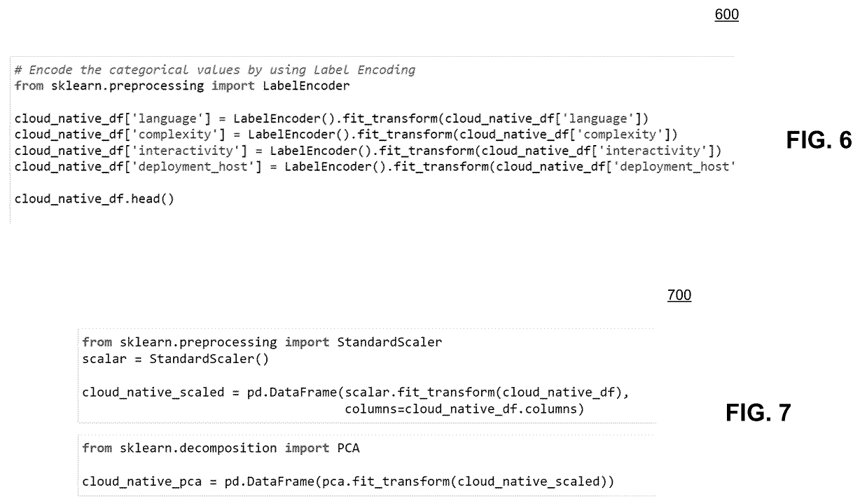

FIG. 5B depicts example pseudocode 502 for loading the historical deployment data and metadata in the form of cloud application runtime metrics into a Pandas data frame for building the training data. The data may be in the form of a CSV file. Since machine learning works with vectors (e.g., numbers), categorical and textual attributes like code language, complexity tier, interactivity, cloud provider (“deployment host”), etc. must be encoded before being used as training data. In one or more embodiments, this can be achieved by leveraging a LabelEncoder function of ScikitLearn library as shown in the pseudocode 600 in FIG. 6.

A further step in the process is to reduce the dimensionality of the dataset by applying principal component analysis (PCA). Prior to PCA, the dataset needs to be normalized by applying scaling. This can be achieved by using a StandardScaler function available in ScikitLearn library. After normalization, the data can be passed to a PCA function for dimensionality reduction and made ready for model training. FIG. 7 depicts example pseudocode 700 for normalizing and reducing dimensionality of a dataset.

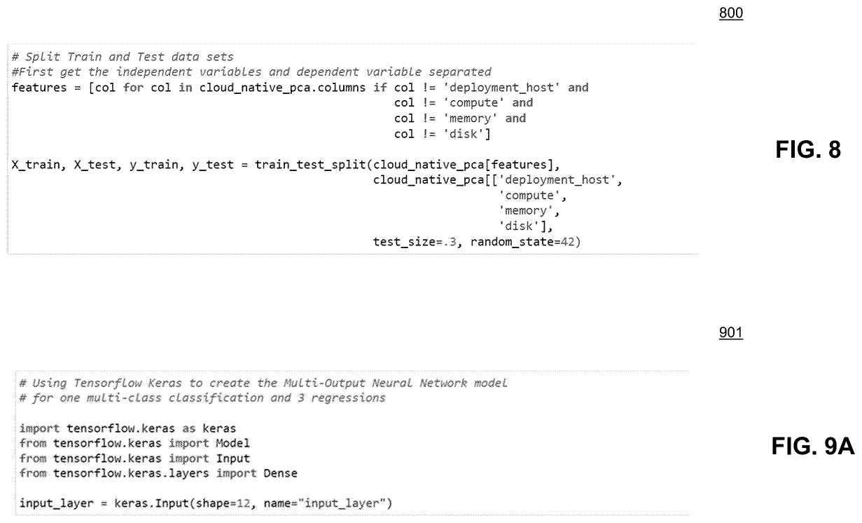

According to illustrative embodiments, the encoded training dataset is split into training and testing datasets, and separate datasets are created for independent variables and dependent variables. FIG. 8 depicts example pseudocode 800 for splitting a dataset into training and testing components and for creating separate datasets for independent (X) and dependent (y) variables. The dataset is split into training and testing datasets using train_test_split function of ScikitLearn library with, for example, a 70%-30% split. Considering this is a multi-output prediction with both multi-class classification and regression use cases, and a dense neural network will be used as the model, it is important to scale the data before passing the data to the model. Since scaling is already done before PCA, there is no need to scale the data again. At the end of these activities, the data is ready for model training and testing.

Once the datasets are ready for training and testing, a multi-layer, multi-output capable dense neural network is created using a Keras library. The neural network is built using a Keras functional model, with four separate branches being created and added to the functional model. Two separate dense layers are added to the input layer with each branch predicting different targets (e.g., cloud provider, CPU utilization, memory utilization and disk I/O utilization).

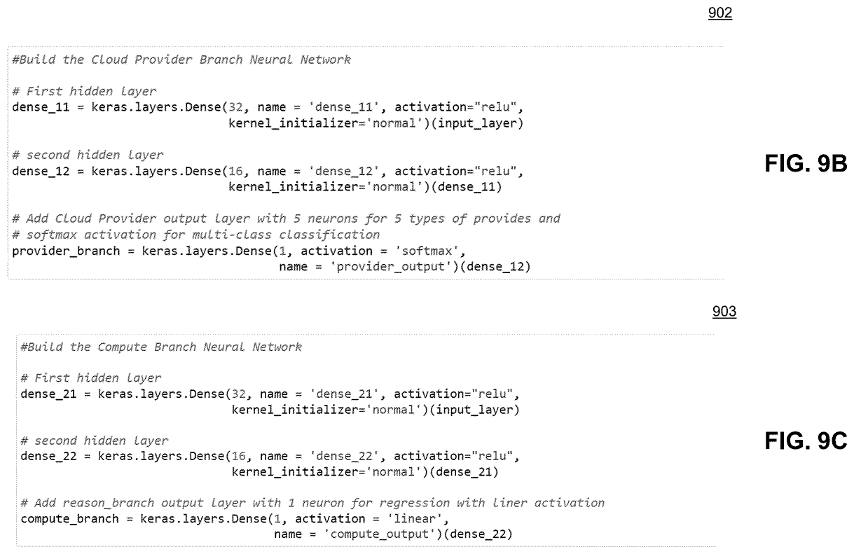

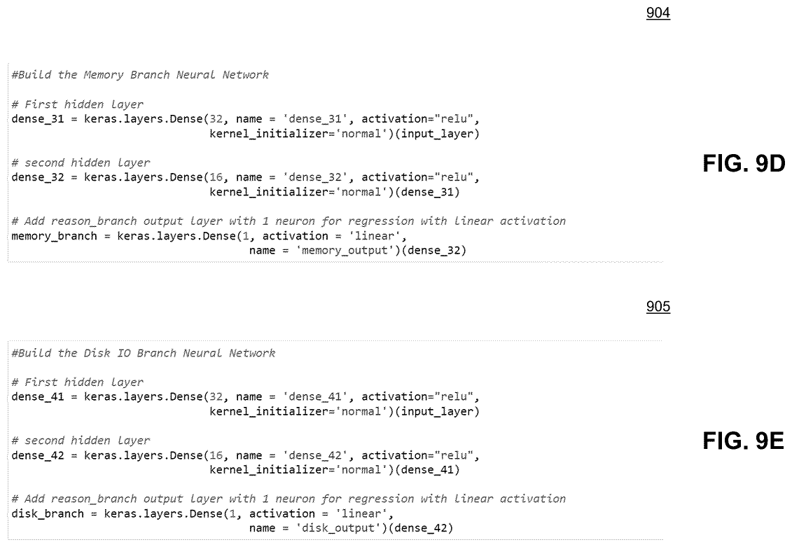

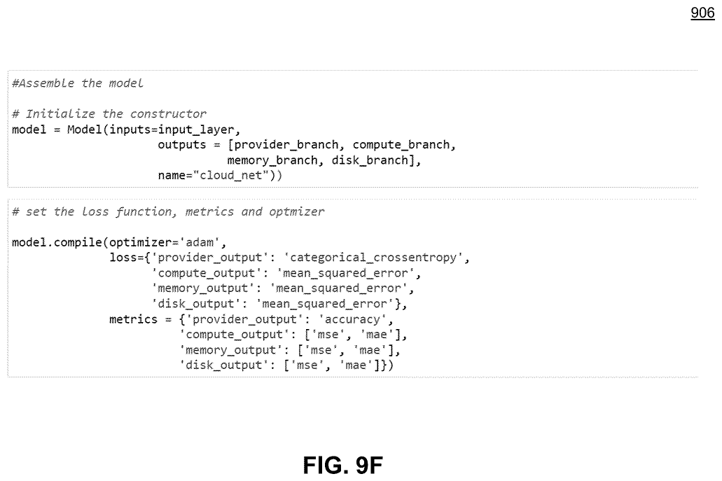

FIG. 9A depicts example pseudocode 901 for using a designated library to build the neural network. For example, Tensorflow® and Keras libraries are used. The input layer is created with 12 neurons and then four parallel branches are created from the same input layer.

FIG. 9B depicts example pseudocode 902 for building a cloud provider branch of the neural network. In this case, the cloud provider branch has five neurons for five types of cloud providers and uses a softmax activation function for multi-class classification. FIG. 9C depicts example pseudocode 903 for building a compute utilization branch of the neural network. FIG. 9D depicts example pseudocode 904 for building the memory utilization branch of the neural network. FIG. 9E depicts example pseudocode 905 for building the disk I/O value branch of the neural network. Each of these parallel branches includes one neuron for regression with linear activation. Each of these parallel branches have two hidden layers with 32 neurons in the first layer and 16 in the second layer. The hidden layers use ReLu as the activation function. Once the branches are created, they are assembled into the main model.

FIG. 9F depicts example pseudocode 906 for assembling the neural network and setting a loss function, metrics and an optimizer of a neural network. Referring to the pseudocode 906, using a model function, the functional model including the cloud provider branch, compute utilization branch, memory utilization branch and disk I/O value branch is created. Once the model is created, loss function, optimizer type and validation metrics are added to the model using a compile function. As noted herein above, “categorical_crossentropy” and “mean_squared error” are used as the loss functions, adam is used as the optimizer and “accuracy,” “mse” and “mae” are used as validation metrics.

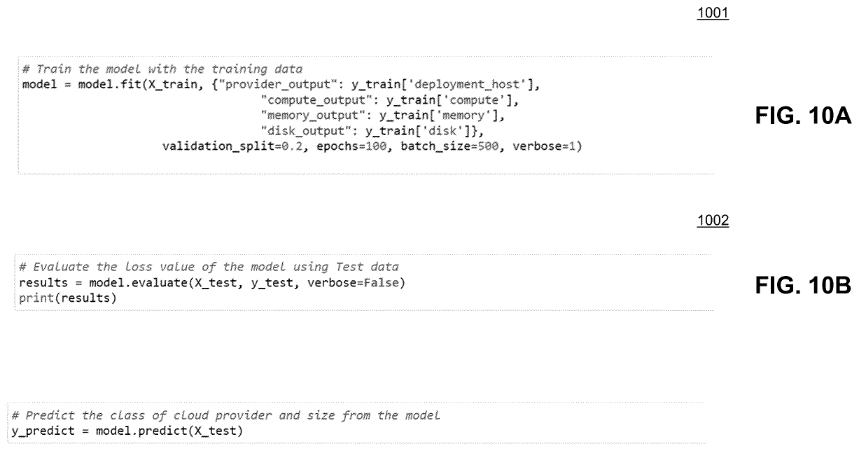

Referring to the pseudocode 1001 for training a neural network model in FIG. 10A, neural network model training can be achieved by calling a fit( ) function of the model and passing training data through the neural network for a designated number of epochs. After the model completes a designated number of epochs, the model is trained and ready for validation. Referring to the pseudocode 1002 for evaluating a loss value of a neural network model in FIG. 10B, a loss/error value can be obtained by calling an evaluate( ) function of the model and passing test data through the neural network. The loss value indicates how well the model is trained. A higher loss value means the model is not trained enough, so hyperparameter tuning is required. The number of epochs can be increased to train the model more. Other hyperparmeter tuning can be done by changing the loss function, optimizer algorithm and/or making changes to the neural network architecture by adding more hidden layers. Once the model is fully trained with a reasonable value of loss (as close to 0 as possible), the model is ready for prediction. Referring to the pseudocode 1003 for predicting cloud provider and cloud instance configuration, prediction of the model is achieved by calling a predict( ) function of the model and passing the independent variables of test data through the neural network (for comparing training vs test data) or passing the real values through neural network to predict a cloud provider and cloud instance configuration (target variables).

In illustrative embodiments, once deployed, the cloud application deployment workflow engine 120 updates the cloud provider and configuration prediction engine 130 with a digest of the cloud application, the utilized cloud provider platform 105 and cloud instance configuration data. Data and metadata corresponding to the cloud instance and features of the cloud application and the corresponding cloud provider platform 105 are persisted in the cloud application data and metadata repository 150 for future training of the machine learning models used by the cloud provider and configuration prediction engine 130. In addition, runtime metrics corresponding to the deployment of cloud applications from the cloud provider platforms 105 are captured from the cloud provider platforms 105 by the cloud provider interface and monitoring engine 140 on a periodic basis. As explained in more detail herein, such capturing of runtime metrics can be achieved by calling appropriate software development kits (SDKs) and APIs (for example boto3 in AWS). The runtime metrics data and metadata are stored in the cloud application data and metadata repository 150 for future training of the machine learning models used by the cloud provider and configuration prediction engine 130.

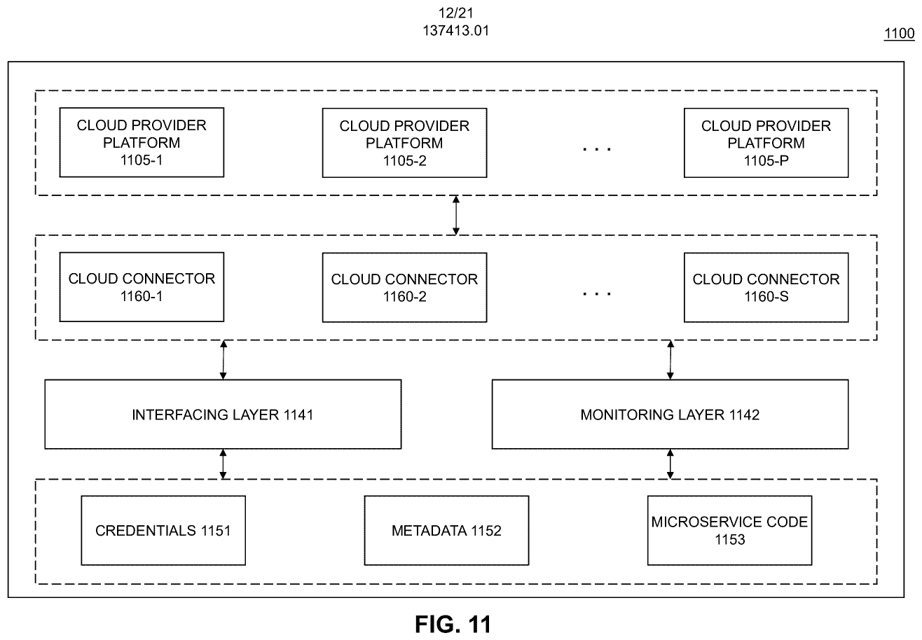

Referring to the operational diagram 1100 in FIG. 11, the interfacing layer 1141, which is the same or similar to the interfacing layer 141 of the cloud provider interface and monitoring engine 140, functions as an abstraction layer for various cloud providers and hides the complexities of interfacing with cloud application deployments from requesters of cloud application deployments. The interfacing layer 1141 interfaces with the cloud provider platforms 1105-1, 1105-2, . . . 105-P (collectively “cloud provider platforms 1105”) via one or more cloud connectors 1160-1, 1160-2, . . . 1160-S (collectively “cloud connectors 1160”). The cloud provider platforms 1105 may be the same as or similar to the cloud provider platforms 105. As different cloud provider platforms 1105 use different APIs and metadata types, the interfacing layer 1141 creates the appropriate interfaces, data types and calls the necessary APIs of the cloud provider platform 1105 on which a cloud application is to be deployed to receive the runtime metrics like CPU, memory, and disk I/O utilization of each deployed application (e.g., microservice, MFE, etc.).

While some of the metadata 1152 may be unique to particular cloud provider platforms 1105, other metadata 1152 may be universal to the cloud provider platforms 1105. For example, information like microservice code 1153, function_name, function description, run_time (e.g., python 3.10), deployment region, etc., can be the same across different cloud provider platforms 1105. Some information may be specific to a cloud provider platform 1105, such as, for example, identity credentials (e.g., credentials 1151), storage locations (e.g., S3 bucket), etc.

The monitoring layer 1142, which is the same or similar to the monitoring layer 142 of the cloud provider interface and monitoring engine 140, monitors the existing (e.g., already deployed) applications and their corresponding cloud instances in a multi-cloud environment. The monitoring layer 1142 connects to the cloud provider platforms 1105 via one or more cloud connectors 1160. The cloud provider interface and monitoring engine 140 creates custom cloud connectors 1160 using the credentials 1151 and APIs for each cloud provider platform 1105 and uses the cloud connectors 1160 for deployment and monitoring. The monitoring layer 1142 captures runtime metrics of the deployed cloud applications, which can be used as further training data for the machine learning models in the cloud provider and configuration prediction engine 130.

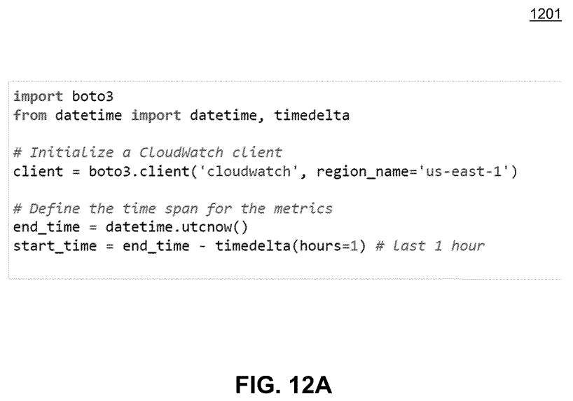

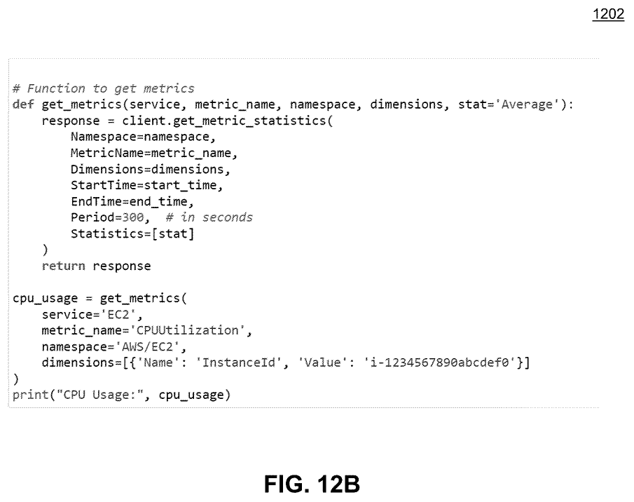

The cloud provider interface and monitoring engine 140 leverages the cloud application code (e.g., microservice code 1153) and associated metadata (e.g., metadata 1152) to build the payload for the appropriate API of the cloud provider platform 105/1105. Pseudocode 1201 and 1202 for retrieval of CPU utilization metrics from an AWS® cloud provider platform using boto3 libraries in AWS® is shown in FIGS. 12A and 12B. In this case, the period for retrieval is every five minutes (300 seconds).

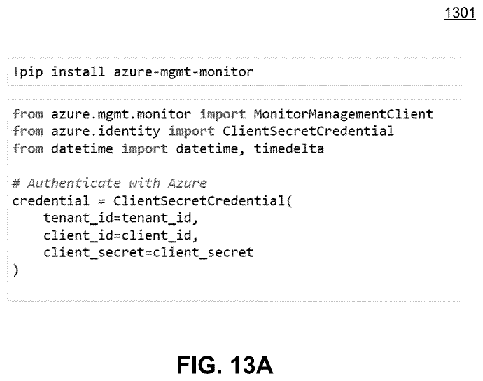

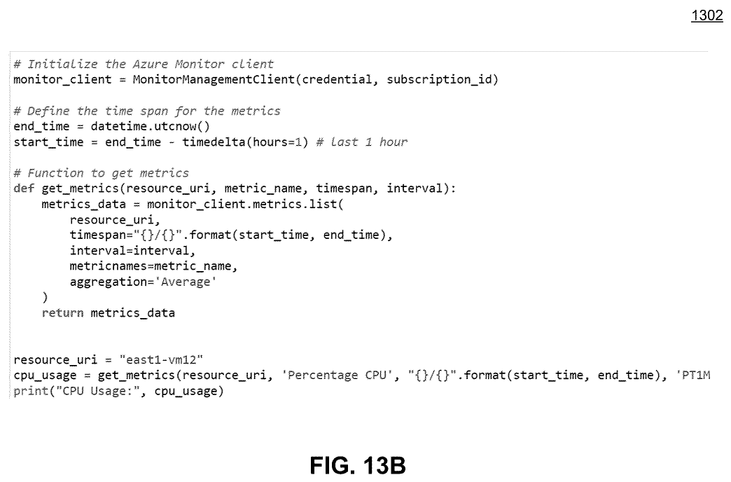

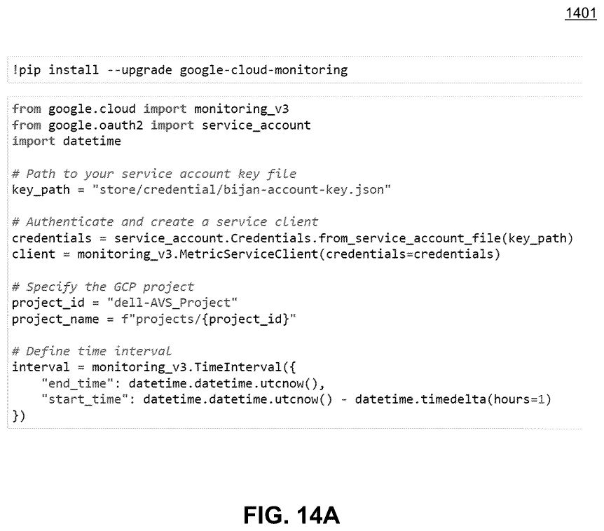

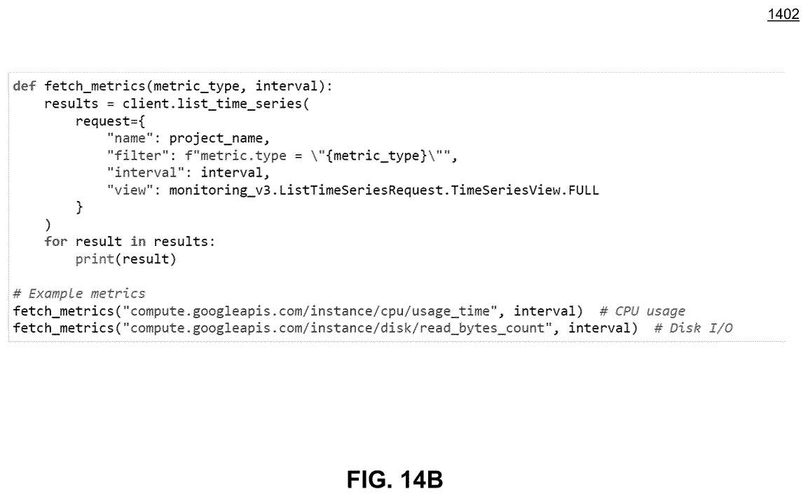

Pseudocode 1301 and 1302 for retrieval of CPU utilization metrics from an Azure® cloud provider platform using an Azure management monitor client library in Azure® is shown in FIGS. 13A and 13B. In this case, the time span for retrieval is one hour. Pseudocode 1401 and 1402 for retrieval of CPU utilization and disk I/O utilization metrics from a Google® cloud provider platform using a Google cloud monitoring library is shown in FIGS. 14A and 14B. In this case, the time span for retrieval is one hour. In illustrative embodiments, the metrics of cloud applications can be obtained by the monitoring layer 142/1142 by calling appropriate services in a public cloud.

In some embodiments, the cloud application data and metadata repository 150 and other data corpuses, repositories or databases referred to herein are implemented using one or more storage systems or devices associated with the cloud instance prediction platform 110. In some embodiments, one or more of the storage systems utilized to implement the cloud application data and metadata repository 150 and other data corpuses, repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the cloud instance prediction platform 110, the cloud application deployment workflow engine 120, cloud provider and configuration prediction engine 130, cloud provider interface and monitoring engine 140 and/or cloud application data and metadata repository 150 in other embodiments can be implemented at least in part externally to the cloud instance prediction platform 110, for example, as stand-alone servers, sets of servers or other types of systems coupled to the network 104. For example, the cloud application deployment workflow engine 120, cloud provider and configuration prediction engine 130, cloud provider interface and monitoring engine 140 and/or cloud application data and metadata repository 150 may be provided as cloud services accessible by the cloud instance prediction platform 110.

The cloud application deployment workflow engine 120, cloud provider and configuration prediction engine 130, cloud provider interface and monitoring engine 140 and/or cloud application data and metadata repository 150 in the FIG. 1 embodiment are each assumed to be implemented using at least one processing device. Each such processing device generally comprises at least one processor and an associated memory, and implements one or more functional modules for controlling certain features of the cloud application deployment workflow engine 120, cloud provider and configuration prediction engine 130, cloud provider interface and monitoring engine 140 and/or cloud application data and metadata repository 150.

At least portions of the cloud instance prediction platform 110 and the elements thereof may be implemented at least in part in the form of software that is stored in memory and executed by a processor. The cloud instance prediction platform 110 and the elements thereof comprise further hardware and software required for running the cloud instance prediction platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the cloud application deployment workflow engine 120, cloud provider and configuration prediction engine 130, cloud provider interface and monitoring engine 140, cloud application data and metadata repository 150 and other elements of the cloud instance prediction platform 110 in the present embodiment are shown as part of the cloud instance prediction platform 110, at least a portion of the cloud application deployment workflow engine 120, cloud provider and configuration prediction engine 130, cloud provider interface and monitoring engine 140, cloud application data and metadata repository 150 and other elements of the cloud instance prediction platform 110 in other embodiments may be implemented on one or more other processing platforms that are accessible to the cloud instance prediction platform 110 over one or more networks. Such elements can each be implemented at least in part within another system element or at least in part utilizing one or more stand-alone elements coupled to the network 104.

It is assumed that the cloud instance prediction platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the cloud application deployment workflow engine 120, cloud provider and configuration prediction engine 130, cloud provider interface and monitoring engine 140, cloud application data and metadata repository 150 and other elements of the cloud instance prediction platform 110, and the elements thereof can each be implemented in the form of one or more LXCs running on one or more VMs. Other arrangements of one or more processing devices of a processing platform can be used to implement the cloud application deployment workflow engine 120, cloud provider and configuration prediction engine 130, cloud provider interface and monitoring engine 140 and cloud application data and metadata repository 150, as well as other elements of the cloud instance prediction platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the cloud instance prediction platform 110 to reside in different data centers. Numerous other distributed implementations of the cloud instance prediction platform 110 are possible.

Accordingly, one or each of the cloud application deployment workflow engine 120, cloud provider and configuration prediction engine 130, cloud provider interface and monitoring engine 140, cloud application data and metadata repository 150 and other elements of the cloud instance prediction platform 110 can each be implemented in a distributed manner so as to comprise a plurality of distributed elements implemented on respective ones of a plurality of compute nodes of the cloud instance prediction platform 110.

It is to be appreciated that these and other features of illustrative embodiments are presented by way of example only, and should not be construed as limiting in any way. Accordingly, different numbers, types and arrangements of system elements such as the cloud application deployment workflow engine 120, cloud provider and configuration prediction engine 130, cloud provider interface and monitoring engine 140, cloud application data and metadata repository 150 and other elements of the cloud instance prediction platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the cloud instance prediction platform can be offered to cloud infrastructure customers or other users as part of FaaS, CaaS and/or PaaS offerings.

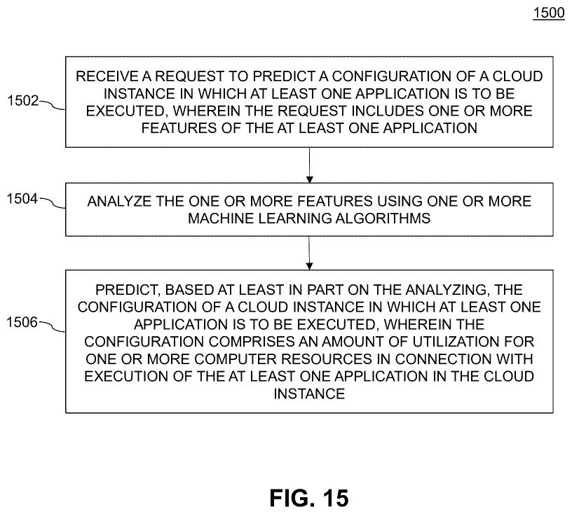

The operation of the information processing system 100 will now be described in further detail with reference to the flow diagram of FIG. 15. With reference to FIG. 15, a process 1500 for cloud instance prediction as shown includes steps 1502 through 1506, and is suitable for use in the system 100 but is more generally applicable to other types of information processing systems comprising a cloud instance prediction platform configured for selecting cloud providers and predicting configurations of cloud instances on which to deploy cloud applications.

In step 1502, a request to predict a configuration of a cloud instance in which at least one application is to be executed is received. The request includes one or more features of the at least one application. In step 1504, the one or more features are analyzed using one or more machine learning algorithms. The one or more features identify, for example, at least one of a size of code for the at least one application, a language of the code for the at least one application, a complexity tier of the at least one application, an interactivity determination of the at least one application and an execution time of the at least one application. In illustrative embodiments, the at least one application comprises at least one of an MFE application and a microservice application.

In step 1506, based at least in part on the analyzing, the configuration of a cloud instance in which at least one application is to be executed is predicted. The configuration comprises an amount of utilization for one or more computer resources in connection with execution of the at least one application in the cloud instance. In illustrative embodiments, based at least in part on the analyzing, a cloud platform of a plurality of cloud platforms is selected to host the cloud instance. The cloud instance comprises one of a container and a virtual machine.

In illustrative embodiments, the configuration comprises an amount for at least one of CPU utilization, memory utilization and disk I/O utilization. The one or more machine learning algorithms comprise a neural network configured to predict a plurality of targets, wherein a first target of the plurality of targets is predicted using a classification technique, and remaining targets of the plurality of targets are predicted using a regression technique. The first target comprises a cloud platform of a plurality of cloud platforms to host the cloud instance, and the remaining targets comprise respective amounts for CPU utilization, memory utilization and disk I/O utilization in connection with the execution of the at least one application in the cloud instance.

In illustrative embodiments, the neural network includes a plurality of parallel branches respectively corresponding to the plurality of targets, wherein respective branches of the plurality of parallel branches comprise at least two hidden layers utilizing a rectified linear unit (ReLu) activation function.

In illustrative embodiments, the one or more machine learning algorithms are trained with historical runtime feature data of a plurality of applications. The historical runtime feature data specifies for respective ones of the plurality of applications at least one of: (i) a code size; (ii) a code language; (iii) a complexity tier; (iv) an interactivity determination; and (v) an execution time.

In illustrative embodiments, at least one cloud platform of a plurality of cloud platforms is interfaced with to collect one or more runtime metrics corresponding to execution of a plurality of applications in a plurality of cloud instances. The interfacing comprises generating one or more APIs based at least in part on one or more cloud platform APIs used by the at least one cloud platform, and invoking the one or more generated APIs to collect the one or more runtime metrics from the at least one cloud platform. The one or more runtime metrics are used for training the one or more machine learning algorithms.

It is to be appreciated that the FIG. 15 process and other features and functionality described above can be adapted for use with other types of information systems configured to execute cloud instance prediction services in a cloud instance prediction platform or other type of platform.

The particular processing operations and other system functionality described in conjunction with the flow diagram of FIG. 15 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 15 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a cloud instance prediction platform as disclosed herein can provide a number of significant advantages relative to conventional arrangements. For example, the cloud instance prediction platform uses machine learning to predict cloud instance configurations and automatically select cloud providers for use in connection with deploying different cloud applications. The embodiments advantageously leverage sophisticated machine learning classification and regression techniques that are trained using multi-dimensional, historical feature data and runtime metrics of a plurality of applications to predict cloud providers and cloud instance configurations that are most appropriate for given cloud applications.

Unlike conventional approaches, which use static, hard-coded values in a configuration file illustrative embodiments provide technical solutions which, with a high degree of accuracy, predict a cloud provider and the actual resource amounts (CPU utilization, memory utilization, disk I/O utilization, etc.) of an application (e.g., microservice, MFE) hosting instance (e.g., container, pod, VM) by leveraging a sophisticated machine learning algorithm and training it using historical and similar application utilization data. As an additional advantage, the embodiments provide techniques to monitor and capture runtime metrics of current cloud application deployments, and use the captured runtime metrics for training of machine learning models being used to predict the cloud instance configurations and cloud providers for the respective applications.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the cloud instance prediction platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a cloud instance prediction platform in illustrative embodiments. These and other cloud-based systems in illustrative embodiments can include object stores.

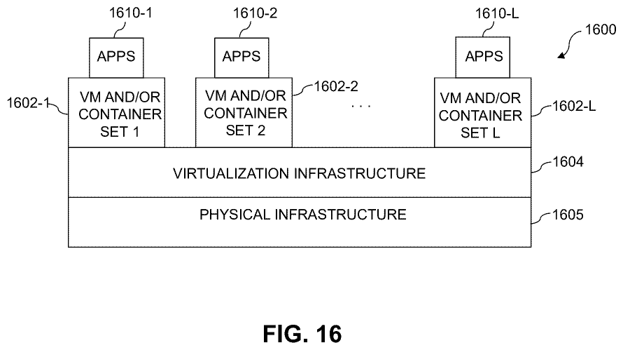

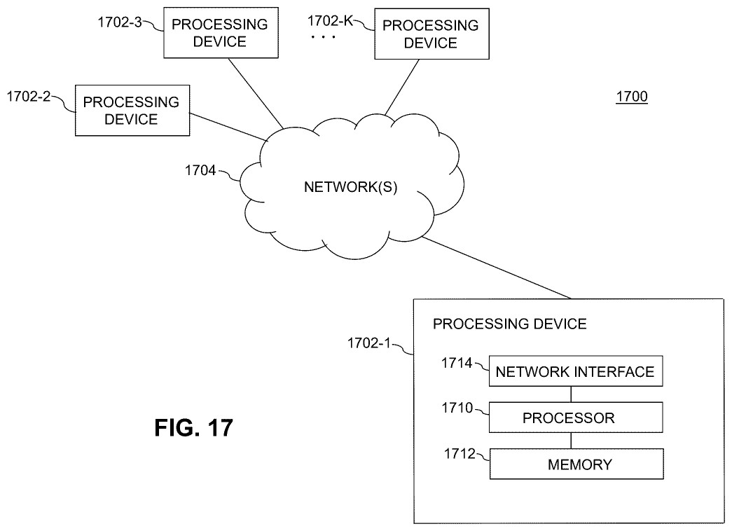

Illustrative embodiments of processing platforms will now be described in greater detail with reference to FIGS. 16 and 17. Although described in the context of system 100, these platforms may also be used to implement at least portions of other information processing systems in other embodiments.

FIG. 16 shows an example processing platform comprising cloud infrastructure 1600. The cloud infrastructure 1600 comprises a combination of physical and virtual processing resources that may be utilized to implement at least a portion of the information processing system 100. The cloud infrastructure 1600 comprises multiple virtual machines (VMs) and/or container sets 1602-1, 1602-2, . . . 1602-L implemented using virtualization infrastructure 1604. The virtualization infrastructure 1604 runs on physical infrastructure 1605, and illustratively comprises one or more hypervisors and/or operating system level virtualization infrastructure. The operating system level virtualization infrastructure illustratively comprises kernel control groups of a Linux operating system or other type of operating system.

The cloud infrastructure 1600 further comprises sets of applications 1610-1, 1610-2, . . . 1610-L running on respective ones of the VMs/container sets 1602-1, 1602-2, . . . 1602-L under the control of the virtualization infrastructure 1604. The VMs/container sets 1602 may comprise respective VMs, respective sets of one or more containers, or respective sets of one or more containers running in VMs.

In some implementations of the FIG. 16 embodiment, the VMs/container sets 1602 comprise respective VMs implemented using virtualization infrastructure 1604 that comprises at least one hypervisor. A hypervisor platform may be used to implement a hypervisor within the virtualization infrastructure 1604, where the hypervisor platform has an associated virtual infrastructure management system. The underlying physical machines may comprise one or more distributed processing platforms that include one or more storage systems.

In other implementations of the FIG. 16 embodiment, the VMs/container sets 1602 comprise respective containers implemented using virtualization infrastructure 1604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1600 shown in FIG. 16 may represent at least a portion of one processing platform. Another example of such a processing platform is processing platform 1700 shown in FIG. 17.

The processing platform 1700 in this embodiment comprises a portion of system 100 and includes a plurality of processing devices, denoted 1702-1, 1702-2, 1702-3, . . . 1702-K, which communicate with one another over a network 1704.

The network 1704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1702-1 in the processing platform 1700 comprises a processor 1710 coupled to a memory 1712. The processor 1710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1712 may comprise random access memory (RAM), read-only memory (ROM), flash memory or other types of memory, in any combination. The memory 1712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1702-1 is network interface circuitry 1714, which is used to interface the processing device with the network 1704 and other system components, and may comprise conventional transceivers.

The other processing devices 1702 of the processing platform 1700 are assumed to be configured in a manner similar to that shown for processing device 1702-1 in the figure.

Again, the particular processing platform 1700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the cloud instance prediction platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and cloud instance prediction platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a request to predict a configuration of a cloud instance in which at least one application is to be executed, wherein the request includes one or more features of the at least one application;
analyzing the one or more features using one or more machine learning algorithms; and
predicting, based at least in part on the analyzing, the configuration of a cloud instance in which at least one application is to be executed;
wherein the configuration comprises an amount of utilization for one or more computer resources in connection with execution of the at least one application in the cloud instance; and
wherein the steps of the method are executed by a processing device operatively coupled to a memory.

2. The method of claim 1 further comprising selecting, based at least in part on the analyzing, a cloud platform of a plurality of cloud platforms to host the cloud instance.

3. The method of claim 1 wherein the cloud instance comprises one of a container and a virtual machine.

4. The method of claim 1 wherein the configuration comprises an amount for at least one of central processing unit utilization, memory utilization and disk input-output utilization.

5. The method of claim 1 wherein the one or more features identify at least one of a size of code for the at least one application, a language of the code for the at least one application, a complexity tier of the at least one application, an interactivity determination of the at least one application and an execution time of the at least one application.

6. The method of claim 1 wherein the at least one application comprises at least one of a micro-frontend application and a microservice application.

7. The method of claim 1 wherein:
the one or more machine learning algorithms comprise a neural network configured to predict a plurality of targets;
a first target of the plurality of targets is predicted using a classification technique; and
remaining targets of the plurality of targets are predicted using a regression technique.

8. The method of claim 7, wherein the first target comprises a cloud platform of a plurality of cloud platforms to host the cloud instance, and the remaining targets comprise respective amounts for central processing unit utilization, memory utilization and disk input-output utilization in connection with the execution of the at least one application in the cloud instance.

9. The method of claim 7 wherein:
the neural network includes a plurality of parallel branches respectively corresponding to the plurality of targets; and
respective branches of the plurality of parallel branches comprise at least two hidden layers utilizing a rectified linear unit activation function.

10. The method of claim 1 further comprising training the one or more machine learning algorithms with historical runtime feature data of a plurality of applications.

11. The method of claim 10, wherein the historical runtime feature data specifies for respective ones of the plurality of applications at least one of: (i) a code size; (ii) a code language; (iii) a complexity tier; (iv) an interactivity determination; and (v) an execution time.

12. The method of claim 1 further comprising interfacing with at least one cloud platform of a plurality of cloud platforms to collect one or more runtime metrics corresponding to execution of a plurality of applications in a plurality of cloud instances, wherein the interfacing comprises:
generating one or more application programming interfaces based at least in part on one or more cloud platform application programming interfaces used by the at least one cloud platform; and
invoking the one or more generated application programming interfaces to collect the one or more runtime metrics from the at least one cloud platform.

13. The method of claim 12 wherein the one or more runtime metrics are used for training the one or more machine learning algorithms.

14. An apparatus comprising:
a processing device operatively coupled to a memory and configured:
to receive a request to predict a configuration of a cloud instance in which at least one application is to be executed, wherein the request includes one or more features of the at least one application;
to analyze the one or more features using one or more machine learning algorithms; and
to predict, based at least in part on the analyzing, the configuration of a cloud instance in which at least one application is to be executed;
wherein the configuration comprises an amount of utilization for one or more computer resources in connection with execution of the at least one application in the cloud instance.

15. The apparatus of claim 14 wherein:
the one or more machine learning algorithms comprise a neural network configured to predict a plurality of targets;
a first target of the plurality of targets is predicted using a classification technique; and
remaining targets of the plurality of targets are predicted using a regression technique.

16. The apparatus of claim 15 wherein the first target comprises a cloud platform of a plurality of cloud platforms to host the cloud instance, and the remaining targets comprise respective amounts for central processing unit utilization, memory utilization and disk input-output utilization in connection with the execution of the at least one application in the cloud instance.

17. The apparatus of claim 14 wherein the processing device is further configured to interface with at least one cloud platform of a plurality of cloud platforms to collect one or more runtime metrics corresponding to execution of a plurality of applications in a plurality of cloud instances, wherein the interfacing comprises:
generating one or more application programming interfaces based at least in part on one or more cloud platform application programming interfaces used by the at least one cloud platform; and
invoking the one or more generated application programming interfaces to collect the one or more runtime metrics from the at least one cloud platform.

18. An article of manufacture comprising a non-transitory processor-readable storage medium having stored therein program code of one or more software programs, wherein the program code when executed by at least one processing device causes said at least one processing device to perform the steps of:
receiving a request to predict a configuration of a cloud instance in which at least one application is to be executed, wherein the request includes one or more features of the at least one application;
analyzing the one or more features using one or more machine learning algorithms; and
predicting, based at least in part on the analyzing, the configuration of a cloud instance in which at least one application is to be executed;
wherein the configuration comprises an amount of utilization for one or more computer resources in connection with execution of the at least one application in the cloud instance.

19. The article of manufacture of claim 18 wherein:
the one or more machine learning algorithms comprise a neural network configured to predict a plurality of targets;
a first target of the plurality of targets is predicted using a classification technique; and
remaining targets of the plurality of targets are predicted using a regression technique.

20. The article of manufacture of claim 19 wherein the first target comprises a cloud platform of a plurality of cloud platforms to host the cloud instance, and the remaining targets comprise respective amounts for central processing unit utilization, memory utilization and disk input-output utilization in connection with the execution of the at least one application in the cloud instance.
